(19) United States
(12) Patent Application Publication
(10) Pub. No.: US 2003/0104093 A1
(43) Pub. Date: Jun. 5, 2003

(54) Extruder screw

(75) Inventor: Martin Wurtele, Friedberg (DE)

Correspondence Address: HENRY M FEIEREISEN, 350 FIFTH AVENUE, SUITE 3220, NEW YORK, NY, 10118, US

(73) Assignee: KRAUSS-MAFFEI KUNSTSTOFFTECHNIK GMBH, Munchen (DE)

(21) Appl. No.: 10/282,149

(22) Filed: Oct. 28, 2002

(30) Foreign Application Priority Data
Oct. 31, 2001 (DE) 101 53 711.5
Jan. 15, 2002 (DE) 102 01 158.3

(51) Int. Cl. B29C 47/64

(52) U.S. Cl. 425/208; 366/88; 366/89; 425/587

(57) ABSTRACT

An extruder screw for processing plastic material, in particular for a plasticizing barrel of an injection molding machine, has at least one screw flight divided along its length into successive zones including a mixing and transformation zone for plasticizing plastic material and a subsequent discharge zone for expelling plastic material. The screw flight is formed in the mixing and transformation zone with at least one breach to define a through passage for return of a partial mass flow to a neighboring screw turn, whereby the screw flight extends towards a discharge end of the discharge zone of the extruder screw along a helical line having same thread direction and being offset in axial direction in the area of the breach.

### CROSS-REFERENCES TO RELATED APPLICATIONS

This application claims the priority of German Patent Applications, Serial Nos. 101 53 711.5, filed Oct. 31, 2001, and 102 01 158.3, filed Jan. 15, 2002, pursuant to 35 U.S.C. 119(a)-(d), the disclosure of both of which is incorporated herein by reference.

### BACKGROUND OF THE INVENTION

The present invention relates, in general, to an extruder for processing plastic material, and more particularly to an extruder screw for use in an extruder.

It is generally known to use a screw-type extruder to gradually melt a granular plastic material, introduced into a plasticizing barrel, in a transformation zone into a plasticized mass under the influence of heat. In a transition zone of the screw, the plastic stream in the flow channel contains simultaneously solid and molten fractions. This poses a problem because molten material has increased adhesion and friction so as to collect increasingly at the thrust flank of the screw flight whereas the solids accumulate on the passive or backside of the screw flight. The consequence is a highly undesired segregation of the solid and liquid phases, which adversely affects the thermal homogenization, and the melting process of the plastic material. Various attempts have been undertaken to deal with this problem by forming holes in the screw flight to conduct molten material from the thrust side to the flight backside and from there via the solids bed of the preceding screw turn. Examples include German Pat. Nos. DE 26 22 591 C2 and DE 26 60 469 C2 or U.S. Pat. No. 3,652,064. Hereby, the partial stream of molten material has to be deflected in the flow channel several times transversely to the flow direction solely by the pressure differential at the screw flight, so that a sufficient mixing, if at all, can be realized only by providing an extruder screw which has, with respect to the screw turns, an extremely powerful compression zone. Thus, the overall efficiency is substantially adversely affected. To counter this problem, it has been proposed to install additional inserts in the form of pins, cams or barriers for deflection and mixture of the mass flow. These inserts, however, significantly increase the local flow resistance of the flow channel so that the efficiency is again greatly diminished and also entails the risk that these inserts cause a backup of solids, which can ultimately block the flow channel.

It would therefore be desirable and advantageous to provide an improved extruder screw which obviates prior art shortcomings and which realizes a thorough mixture of the mass flow in the flow channel while still being simple in structure and reliable in operation, without loss of efficiency.

### SUMMARY OF THE INVENTION

According to one aspect of the present invention, an extruder screw for processing plastic material, in particular for a plasticizing barrel of an injection molding machine, has at least one screw flight divided along its length into successive zones including a mixing and transformation zone for plasticizing plastic material and a subsequent discharge zone for expelling plastic material, wherein the screw flight is formed in the mixing and transformation zone with at least one breach to define a through passage for return of a partial mass flow to a neighboring screw turn, whereby the screw flight extends towards a discharge end of the discharge zone of the extruder screw along a helical line having same thread direction and being offset in axial direction in the area of the breach.

The present invention resolves prior art problems by providing an offset arrangement of the screw flight in the area of the through passage, so that melted plastic material can be reliably separated in a flow-enhancing manner, substantially without change in the flow direction and without the provision of inserts that adversely affect the efficiency of the extruder screw, for subsequent return into the solids bed of the preceding channel turn. Thus, a superior thorough mixture of the mass flow is realized with little detrimental effect on the performance, because the geometry of the screw flight not only eliminates interfering constrictions but the recirculation path is widened in cross section in accordance with the mass flow as increased by the returned quantity. This contributed effectively to the significantly improved mass flow, without encountering a backup in the mixing and transformation zone of the extruder screw.

Of course, the axial offset arrangement of the screw flight in the area of the through passage can be modified by continuing the screw flight in circumferential direction at greater distance between the confronting flight portions from one another. The continuation of the screw flight may also be realized through overlapping relationship of the confronting flight portions in circumferential direction, i.e. the flight portions of the screw flight overlap in the area of the through passage.

According to another feature of the present invention, the helical line may have a same pitch or a different pitch. When the screw flight is continued after the through passage in axial offset relationship, it is currently preferred to provide a same pitch.

According to another feature of the present invention, the screw flight may be with provided with a plurality of such breaches to define a plurality of through passages which are spaced from one another at a distance of several screw turns. This construction is suitable for an extrusion screw with a transformation zone that extends over many screw turns so that the mixing procedure can be repeated after several screw revolutions.

When the extruder screw has at least two of screw flights (double-flighted or multi-flighted screw), the through passages of neighboring axially offset flight portions of the screw flights may be spaced from one another at most by a screw turn. Suitably, the axially offset flight portions of the screw flights are aligned in longitudinal screw direction, i.e. at a distance of precisely one screw turn. In this way, the feed area of melt on the passive side and the withdrawal area on the thrust side of the respective flow channel are so positioned relative to one another that the melt can be transferred in a cascade-like manner from one flow channel to the other flow channel, without experiencing that the withdrawn quantity of melted material locally exceeds the feed amount to thereby excessively deplete the mass flow from melt in some places of the flow channel.

According to another feature of the present invention, the axially offset flight portion may have a wedged-shaped leading edge in order to further reduce the flow resistance in the area of the through passage.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a fragmentary sectional view of the mixing and transformation zone of one embodiment of a single-flighted screw according to the present invention, contained in a plasticizing barrel;

FIG. 1a is a fragmentary sectional view of a variation of a single-flighted screw according to the present invention in the mixing and transformation zone;

FIG. 1b is a fragmentary sectional view of another variation of a single-flighted screw according to the present invention in the mixing and transformation zone; and

FIG. 2 is a fragmentary sectional view of the mixing and transformation zone of a double-flighted screw according to the present invention.

### DETAILED DESCRIPTION OF PREFERRED EMBODIMENTS

Throughout all the Figures, same or corresponding elements are generally indicated by same reference numerals.

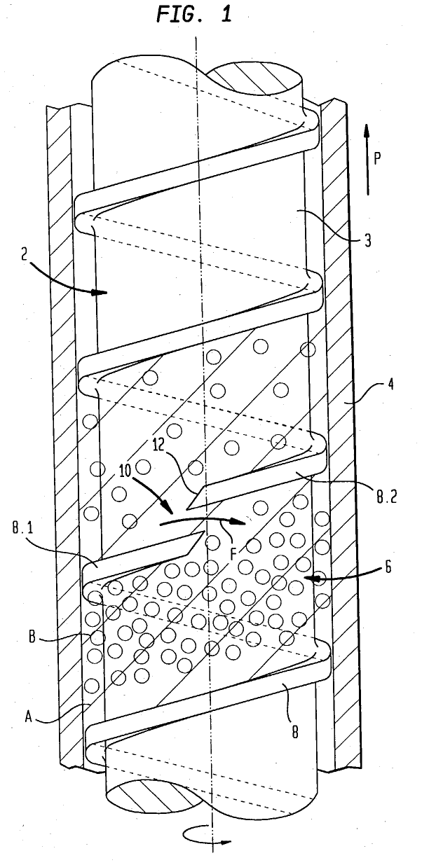

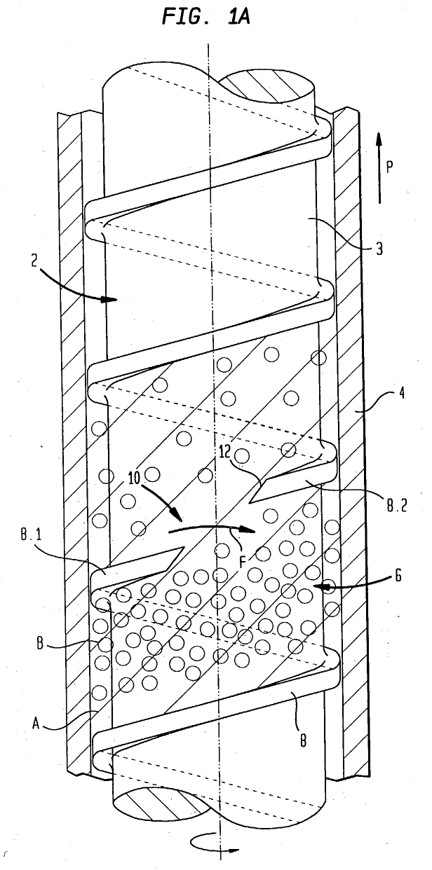

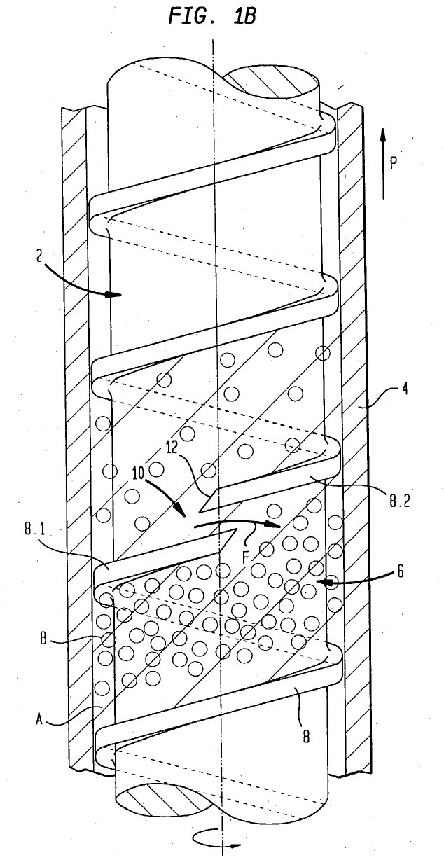

Turning now to the drawing, and in particular to FIG. 1, there is shown a fragmentary sectional view of the mixing and transformation zone of an extruder screw according to the present invention, generally designated by reference numeral 1. The extruder screw 2 has a core 3 with a single screw flight 8 and is accommodated in a plasticizing barrel 4. Although not shown in detail, thermoplastic granulate is introduced in a feed zone of the extruder screw 2 and increasingly melted in the mixing and transformation zone under the influence of heat, and then conveyed by the extruder screw 2 in the direction of arrow P to a discharge zone. As a consequence of its increased adhesive and friction properties, melted plastic material has a tendency to progressively deposit more and more at the thrust side of the screw flight 8, upon passage of the transformation zone, while solids material increasingly accumulate on the back or passive side of the screw flight 8. As a result, segregation has been encountered heretofore of the mass flow into a partial melt stream and a solids bed. Such segregation adversely affects the heat transfer to the solid particles and the thermal homogeneity of the mass flow.

In order to prevent the possibility of segregation, the screw flight 8 is locally breached to define flight portions 8.1 and 8.2 which are offset in axial direction of the extruder screw 2 whereby the screw flight 8 continues after the breach on a helical line of same pitch and same thread direction. Thus, a through passage 10 is formed between the flight portions 8.1, 8.2 to allow a separation and return of the melted plastic material stream, designated by reference character A, to the preceding screw turn for admixture to the solids bed, designated by reference numeral B on the backside of the screw flight 8, while the flow direction of the mass flow in the flow channel 6 is maintained. Due to the offset flight geometry, the flow channel 6 is wider in cross section along the channel turn forming the recirculation path so that the solids bed B is broken up, when flowing into the wider channel section, and the melt stream flowing in the direction of arrow F through the through passage 10 can stream over the solid particles. This ensures a thorough mixture of the solid and liquid partial mass flows A, B, without encountering a backflow.

A further reduction of flow resistance at the through passage 10 can be realized by configuring the flight portion 8.2 with a wedge-shaped leading edge 12. It is also possible to arrange the flight portions 8.1, 8.2 in circumferential direction at greater distance from one another, as shown in FIG. 1a, or to arrange the flight portions 8.1, 8.2 in overlapping relationship, as shown in FIG. 1b.

In order to maintain the mixed state of the mass flow along the entire transformation zone, the screw flight 8 may be formed with a plurality of identically configured through passages 10 at a distance of few screw turns.

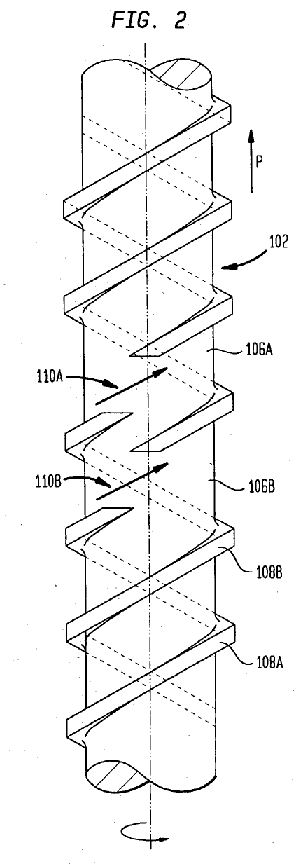

Turning now to FIG. 2, there is shown a fragmentary sectional view of the mixing and transformation zone of an extruder screw 102 according to the present invention. In the following description, parts corresponding with those in FIG. 1 will be identified by corresponding reference numerals each increased by “100”. The extruder screw 102 has two screw flights 108A, 108B with respective flow channels 106A, 106B which are locally connected via through passages 110A, 110B which are formed in the screw flights 108A, 108B, respectively, as breaches, whereby the screw flights 108A, 108B are each continued axially offset along a helical line with same thread direction and pitch toward the discharge end (not shown) of the extruder screw 102. Both through passages 110A, 110B are in alignment in longitudinal screw direction.

Melt is drawn at the through passage 110B from the thrust side of the flow channel 106A and admixed to the solids bed of the mass flow in the flow channel 106B. The mass flow increased by the recirculated melt fraction flows after a channel turn in the wider section of the flow channel 106B to the through passage 110A where the melt layer is separated from the thrust side of the screw flight 108B and mixed to the solids bed of the mass flow in the flow channel 106A. As a result of the axial offset of the flight portion, the cross sectional width of the flow channels 106A, 106B changes in the area of the mixing zone in accordance with the partial melt stream fed or withdrawn locally, so as to realize a superior thorough mixing of the solid and melted material fractions in both flow channels 106A, 106B, without backup and without relevant loss in efficiency, in conjunction with the cascade like, flow-enhancing return of the melt layers on the thrust side of the screw flight.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. In an extruder for processing plastic material, in particular for a plasticizing barrel of an injection molding machine, an extruder screw has at least one screw flight divided along its length into successive zones including a mixing and transformation zone for plasticizing plastic material and a subsequent discharge zone for expelling plastic material, wherein the screw flight is formed in the mixing and transformation zone with at least one breach to define a through passage for return of a partial mass flow to a neighboring screw turn, whereby the screw flight extends towards a discharge end of the discharge zone of the extruder screw along a helical line having same thread direction and being offset in axial direction in the area of the breach.

2. The extruder screw of claim 1, wherein the screw flight has confronting flight portions in overlapping relationship in the area of the breach.

3. The extruder screw of claim 1, wherein the screw flight has confronting flight portions in extended spaced-apart relationship in circumferential direction so that the through passage is increased in size.

4. The extruder screw of claim 1, wherein the helical line has a same pitch.

5. The extruder screw of claim 1, wherein the helical line has a different pitch.

6. The extruder screw of claim 1, wherein the screw flight is provided with a plurality of said breach to define a plurality of through passages spaced from one another at a distance of several screw turns.

7. The extruder screw of claim 1, having at least two of said screw flight, wherein axially offset flight portions of the screw flights are spaced from one another at most by a screw turn.

8. The extruder screw of claim 7, wherein the axially offset flight portions of the screw flights are aligned in longitudinal screw direction.

9. The extruder screw of claim 1, wherein the screw flight defines an axially offset flight portion having a wedged-shaped leading edge.

10. An extruder screw, comprising a core defining a longitudinal axis and having at least one screw flight divided along its length into successive zones including a mixing and transformation zone for plasticizing plastic material, wherein the screw flight is formed in the mixing and transformation zone with at least one breach to define two confronting flight portions which are spaced from one another in direction of the longitudinal axis to define a through passage.
